(19) United States
(12) Patent Application Publication
(10) Pub. No.: US 2026/0278383 A1
(43) Pub. Date: Sep. 17, 2026

(54) Recognition-Informed Neural Network Optimizer (RINNO) for Enhanced Neural Network Training Efficiency, Stability, and Performance

(71) Applicant: Jonathan Washburn, Austin, TX (US)

(72) Inventor: Jonathan Washburn, Austin, TX (US)

(21) Appl. No.: 19/560,933

(22) Filed: Mar. 9, 2026

Related U.S. Application Data
(60) Provisional application No. 63/770,721, filed on Mar. 12, 2025.

(51) Int. Cl. G06N 3/084

(52) U.S. Cl. CPC G06N 3/084

(57) ABSTRACT

A recognition-informed neural network optimizer (RINNO) improves neural network training efficiency, stability, and performance using bounded, monotone transformations based on a recognition-derived constant X_opt. In some embodiments, X_opt is defined as phi/pi, where phi=(1+sqrt(5))/2 and pi is the circular constant, such that X_opt is less than 1. A neural network architecture may be configured by generating a layer width schedule as a function of depth using N_cont(l)=N_base*(X_opt\hat{ }l) and mapping the schedule to integer widths subject to deployment constraints. Model parameters may be initialized using a bounded sign-preserving mapping W_init=W/(|W|+X_opt) that yields initialized magnitudes less than 1. Training may be performed using a bounded loss based on prediction error, including a per-sample term L_i=(e/(e+X_opt))\hat{ }2, thereby limiting per-sample contribution and improving stability for large-error samples.

### CROSS-REFERENCE TO RELATED APPLICATIONS

This application claims the benefit of U.S. Provisional Patent Application No. 63/770,721, filed Mar. 12, 2025, entitled “Recognition-Informed Neural Network Optimizer (RINNO) for Enhanced Neural Network Training Efficiency, Stability, and Performance,” the entire contents of which are hereby incorporated by reference in their entirety for all purposes.

### BACKGROUND OF THE INVENTION

The present disclosure relates to training of machine learning models and neural networks. More particularly, the present disclosure relates to techniques for configuring neural network architectures, initializing neural network parameters, and computing training objectives in a manner that improves training efficiency, stability, and performance, including in deep learning systems implemented on general purpose processors, graphics processing units, tensor processing units, and other computing hardware.

Neural networks are widely used for classification, regression, forecasting, control, and other machine learning tasks. In many deployments, the accuracy and robustness of a trained model depends not only on the availability of data, but also on the selection of the model architecture, parameter initialization procedures, and training objectives (loss functions), as well as associated optimization hyperparameters.

In conventional practice, neural network architectures are frequently defined using manually selected layer sizes, including uniform-width multi-layer perceptrons, hand-designed convolutional channel schedules, or empirically determined hidden dimensions in attention-based architectures. Architecture choices are commonly selected through trial-and-error, heuristics, or computationally intensive search procedures. Such approaches can increase development time and computational cost, can be sensitive to training conditions, and may yield architectures that are larger than necessary for a given task or deployment constraint.

Parameter initialization also impacts training behavior. Conventional initialization schemes, such as variance-preserving initializations and other heuristics, may still exhibit sensitivity to network depth, width, activation functions, normalization layers, and dataset characteristics. In some cases, poor initialization may contribute to instability during early training, including large activation magnitudes, large gradient magnitudes, vanishing gradients, exploding gradients, or slow convergence.

Loss functions similarly affect training stability and convergence. Many commonly used loss functions can produce large per-sample contributions and large gradients when the model error is large, for example due to outliers, label noise, or distribution shift. As a result, a small number of samples may disproportionately influence parameter updates, which can cause oscillatory behavior, unstable training, and reduced convergence reliability. Additionally, practical systems often require losses that are compatible with standard gradient-based training pipelines while maintaining predictable bounded behavior.

Accordingly, there remains a need for neural network training techniques that improve stability and efficiency while remaining compatible with standard training systems and that reduce the degree of manual tuning required for network configuration, initialization, and loss selection. There further remains a need for approaches that provide bounded and well-behaved transformations and objectives that can be implemented efficiently in common training frameworks and deployed across a range of neural network types and computing environments.

### SUMMARY OF THE INVENTION

The present disclosure provides a recognition-informed neural network optimizer (RINNO) that improves training efficiency, stability, and performance by applying one or more bounded, monotone transformations to neural network configuration and training. In various embodiments, RINNO is implemented as (i) a recognition-informed layer sizing technique that determines layer widths as a function of depth using a recognition-derived constant, (ii) a recognition-informed weight initialization technique that maps initial parameter values to bounded values while preserving sign, and/or (iii) a recognition-informed loss function that bounds per-sample loss contributions and yields stable gradients under large-error conditions.

As used herein, “recognition-derived” and “recognition-informed” refer to using a predetermined constant X_opt (preferably X_opt=phi/pi) within bounded, monotone functional forms to configure at least one of (i) architecture sizing, (ii) parameter initialization, and/or (iii) training loss computation. In embodiments using an approximation, X_opt is stored or computed to a selected precision while remaining less than 1.

In some embodiments, the recognition-derived constant is defined as X_opt=phi/pi, where phi=(1+sqrt(5))/2 and pi is the circular constant, such that X_opt is less than 1. In such embodiments, layer sizing is performed by computing a continuous width schedule as N_cont(l)=N_base*(X_opt\hat{ }l), where N_base is a base width and l is a layer index, and then mapping the continuous schedule to integer widths using rounding and optional hardware-aligned quantization. In this manner, the resulting architecture may taper with depth, thereby reducing parameter count and computational cost while maintaining representational capacity.

In some embodiments, weight initialization is performed by applying an elementwise bounded transform to initial weight samples W to produce initialized weights W_init according to W_init 32 W/(|W|+X_opt). This transform yields bounded magnitudes with |W_init|<1 while preserving the sign of each weight element. In practice, the bounded initialization may reduce the risk of unstable early training dynamics associated with large activations or gradients, while remaining compatible with conventional training frameworks and backpropagation.

In some embodiments, a recognition-informed loss is computed using a recognition coverage function F_cov(r)=r/(r+X_opt) applied to a nonnegative prediction error r. For a scalar error e=|y−y_hat|, a per-sample loss may be computed as L_i=(e/(e+X_opt))\hat{ }2, and a batch loss may be computed as a sum or mean over samples. Because each per-sample term is bounded below 1 for finite error and equals zero at perfect prediction, the loss can reduce the influence of outliers and reduce instability caused by large-error samples, while remaining differentiable (or subdifferentiable) and compatible with gradient-based optimizers.

In some embodiments, RINNO is executed by a computing system that configures a neural network architecture, initializes model parameters, computes the recognition-informed loss during training, and updates parameters using a selected optimizer including, by way of example, stochastic gradient descent, Adam, AdamW, or RMSProp. In some embodiments, one or more mathematical properties of the constant selection, the bounded transforms, and the loss function are verified using machine-checkable proofs, thereby enabling validation that key bounds and monotonicity properties hold as implemented.

The foregoing summary is illustrative only and is not intended to limit the scope of the present disclosure. Additional features, embodiments, and advantages will be apparent from the accompanying drawings and the detailed description that follows.

### BRIEF DESCRIPTION OF THE DRAWINGS

FIG. 1 illustrates an example layer sizing relationship, in which a plot region 100 includes an example tapering schedule curve 102 and representative tick marks 104, 106.

FIG. 2 illustrates an example bounded weight initialization mapping, in which a plot region 200 includes a mapping curve 202 and a reference line 204, along with representative tick marks 206.

FIG. 3 illustrates an example bounded loss mapping, in which a plot region 300 includes a loss curve 302 and an upper bound reference line 304, along with representative tick marks 306.

FIG. 4 illustrates an example convergence behavior comparison, in which a plot region 400 includes a first training trajectory 402 and a second training trajectory 404, along with representative tick marks 406.

FIG. 5 illustrates an example neural network architecture 500 having successive layers 502, 504, 506, 508, 510 coupled by interconnects 512.

FIG. 6 illustrates an example computing system 600 implementing RINNO, including processors 602, memory 604, input/output interfaces 606, and data stores 608, as well as training data 610 and configuration parameters 612, and modules including a layer sizing module 620 producing a width schedule 622, a weight initialization module 630 processing raw weights 632 to produce initialized weights 634, a loss module 640 producing a bounded loss 642, a training loop and optimizer interface 650 using an optimizer 652 to produce trained parameters 654 and performance metrics 656, and an optional verification interface 660 producing verification artifacts 662.

FIG. 7 illustrates an example method 700 of configuring and training a neural network using RINNO, including steps 702, 704, 706, 708, 710, 712, and 714.

FIG. 8 illustrates example integer mapping and deployment constraints for a recognition-informed width schedule, in which a plot region 800 includes a staircase mapping 802 and representative tick marks 804.

FIG. 9 illustrates example bounded-gradient behavior associated with a recognition-informed bounded loss, in which a plot region 900 includes a gradient behavior curve 902 and a baseline reference line 904, along with representative tick marks 906.

### DETAILED DESCRIPTION OF THE INVENTION

The following description is presented to enable any person skilled in the art to make and use the disclosed subject matter and to set forth the best mode contemplated by the inventor for carrying out the disclosure. Various modifications to the described embodiments will be readily apparent to those skilled in the art, and the general principles described herein may be applied to other embodiments without departing from the spirit or scope of the disclosure. Accordingly, the disclosed subject matter is not intended to be limited to the embodiments shown, but is to be accorded the widest scope consistent with the principles and features disclosed herein.

Unless otherwise indicated, the functions described herein may be performed by one or more processors executing stored instructions, including a general-purpose processor, a graphics processing unit, a tensor processing unit, a neural processing unit, or other computing hardware, in any combination. The disclosed techniques may be implemented in software, hardware, firmware, or any combination thereof, and may be deployed in training environments including single-device training, distributed data-parallel training, and mixed-precision training.

As used herein, “neural network” includes, without limitation, a multi-layer perceptron, a convolutional neural network, a recurrent neural network, a transformer or attention-based network, a graph neural network, an encoder-decoder model, a mixture-of-experts model, or any hybrid thereof. As used herein, “layer” includes, without limitation, an affine or convolutional layer, an attention projection or attention block, an embedding layer, a normalization layer, a residual block, or any other compositional unit having one or more parameters and/or intermediate activations.

In various embodiments, the disclosed recognition-informed neural network optimizer (RINNO) includes one or more of: a recognition-informed layer sizing procedure configured to determine layer sizes or channel counts as a function of depth; a recognition-informed weight initialization procedure configured to map initial parameter values to bounded values; and a recognition-informed bounded loss procedure configured to compute a bounded per-sample loss contribution based on prediction error. In some embodiments, these procedures are used together, while in other embodiments any subset of the procedures is used, including layer sizing alone, weight initialization alone, or bounded loss alone.

In various embodiments, the layer sizing procedure, bounded initialization, and bounded loss share a common inventive concept of using the same recognition-derived constant X_opt in bounded, monotone functional forms that collectively improve training stability and efficiency in a single training pipeline, and the disclosed embodiments are intended to be examined as a unified invention.

In various embodiments, a recognition-derived constant X_opt is used to define one or more of the above procedures. In a preferred embodiment, X_opt is defined as X_opt=phi/pi, where phi=(1+sqrt(5))/2 and pi is the circular constant, such that X_opt is less than 1. In other embodiments, X_opt may be stored as a numeric constant approximating phi/pi to a selected precision, or computed using an equivalent expression that produces a constant less than 1 and within a neighborhood of the preferred value.

In various embodiments, a recognition coverage function is defined as F_cov(r)=r/(r+X_opt) for r greater than or equal to zero. The recognition coverage function is monotone increasing in r and yields a bounded output in the interval [0, 1) for finite r. In some embodiments, the recognition coverage function is used directly or indirectly to define bounded transforms for weight initialization and/or bounded loss computation, as described herein.

FIG. 6 illustrates an example computing system 600 implementing RINNO. In the illustrated embodiment, the system 600 includes one or more processors 602, memory 604, one or more input/output interfaces 606, and one or more data stores 608. The memory 604 stores instructions that, when executed by the one or more processors 602, cause the system 600 to configure a neural network architecture, initialize neural network parameters, compute a training loss, and iteratively update the parameters using a selected optimizer. The system 600 may be implemented in a single computing device or across multiple networked computing devices, including in cloud computing environments.

In various embodiments, the system 600 receives training data 610 comprising labeled and/or unlabeled samples. The training data 610 may include input-output pairs for supervised learning, input-only samples for unsupervised learning, and/or experience tuples for reinforcement learning, and may be stored in the data store 608 or received via the input/output interface 606. In some embodiments, the system 600 also receives one or more configuration parameters 612 including, by way of example, a model type identifier, a base width or channel count N_base, a depth value L, and one or more training hyperparameters such as batch size, learning rate, weight decay, optimizer selection, and number of training steps.

In various embodiments, the system 600 includes a layer sizing module 620 configured to determine a width schedule 622 for a neural network as a function of depth based on the recognition-derived constant X_opt. The width schedule 622 may specify, by way of example, a number of neurons for each layer in an MLP, a channel count for each stage or block in a convolutional network, one or more hidden dimensions for a transformer, or any other architectural size parameter. In some embodiments, the layer sizing module 620 computes a continuous schedule and maps the schedule to integer values using rounding and optional deployment constraints, as described further herein.

In various embodiments, the system 600 includes a weight initialization module 630 configured to initialize one or more neural network parameters using a bounded mapping. In some embodiments, the weight initialization module 630 receives raw weight samples 632 generated according to a selected initialization distribution and transforms the raw weight samples 632 to produce initialized weights 634 using an elementwise bounded mapping that depends on X_opt. In some embodiments, the initialized weights 634 have bounded magnitude, such that each element has magnitude less than 1, and the mapping preserves sign for nonzero raw weight samples, thereby reducing risk of unstable early training dynamics.

In various embodiments, the system 600 includes a loss module 640 configured to compute a recognition-informed bounded loss 642 during training. In some embodiments, the loss module 640 computes, for each training sample or for each element of a training sample, a nonnegative error magnitude r and applies the recognition coverage function to compute a bounded value F_cov(r). In some embodiments, the loss module 640 computes a per-sample loss term as a power of F_cov(r), including a squared form, and aggregates per-sample loss terms across a batch by summation or averaging to produce the recognition-informed bounded loss 642.

In various embodiments, the system 600 includes a training loop and optimizer interface 650 configured to execute a training loop using the width schedule 622, the initialized weights 634, and the recognition-informed bounded loss 642. In some embodiments, the training loop and optimizer interface 650 performs forward propagation to compute predictions, computes the recognition-informed bounded loss 642, performs backpropagation to compute gradients, and applies a parameter update using an optimizer 652 selected from, by way of example, stochastic gradient descent, momentum-based methods, adaptive methods including Adam and AdamW, or other gradient-based optimizers. In some embodiments, the output of training includes trained parameters 654 and one or more performance metrics 656.

In some embodiments, the system 600 further includes an optional verification interface 660 configured to verify one or more properties of the recognition-derived constant, the bounded mappings, and/or the bounded loss. In some embodiments, the verification interface 660 produces one or more verification artifacts 662 indicating that one or more bounds, monotonicity properties, and/or other mathematical properties hold for the disclosed functions as implemented. In some embodiments, the verification artifacts 662 comprise machine-checkable proofs or certificates generated using a theorem prover.

In various embodiments, the modules described in connection with FIG. 6 may be implemented as software components, library functions, classes, microservices, or other program units within a training framework. In some embodiments, the modules may be combined, omitted, duplicated, or rearranged. For example, in some embodiments the layer sizing module 620 and weight initialization module 630 are integrated into a model construction pipeline, while the loss module 640 and training loop and optimizer interface 650 are integrated into a training pipeline. In some embodiments, RINNO is implemented in a manner compatible with widely used training frameworks and accelerators, including compatibility with mixed-precision arithmetic, distributed training, gradient accumulation, checkpointing, and deployment-driven architectural constraints.

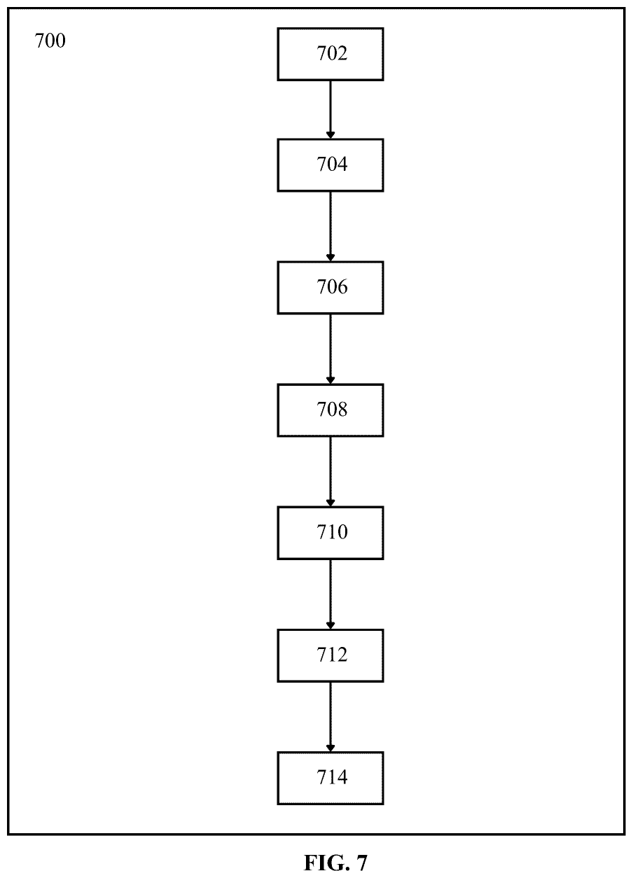

FIG. 7 illustrates an example method 700 for configuring and training a neural network using RINNO. In various embodiments, the method 700 may be performed by the system 600 of FIG. 6, including by one or more processors executing instructions stored in memory. In some embodiments, one or more operations of the method 700 are performed in a different order, in parallel, repeated, and/or omitted, and additional operations may be included without departing from the scope of the disclosure.

In the illustrated embodiment of FIG. 7, an example method 700 includes a sequence of steps 702, 704, 706, 708, 710, 712, and 714. In some embodiments, step 702 includes obtaining configuration inputs and training data, step 704 includes determining the constant X_opt, step 706 includes generating a width schedule, step 708 includes instantiating a neural network using the width schedule, step 710 includes initializing parameters using a bounded mapping, step 712 includes training using a bounded loss, and step 714 includes updating parameters using backpropagation and an optimizer, although steps may be reordered, repeated, or omitted in other embodiments.

In some embodiments, the method 700 includes obtaining configuration inputs for a training run. The configuration inputs may include, by way of example, an identification of a model type, a base width N_base, a depth L, one or more deployment constraints, and one or more training hyperparameters. In some embodiments, N_base corresponds to a width of an input layer, a first hidden layer, an embedding dimension, a channel count, or another architecture sizing parameter depending on model type. In some embodiments, L corresponds to a number of layers, blocks, stages, or other depth units over which a width schedule is to be applied.

In a non-limiting example training run, the base width N_base is selected in a range of 64 to 4096, the depth L is selected in a range of 4 to 200 layers or blocks, an alignment granularity G is selected from {8, 16, 32, 64}, and a minimum width N_min is selected from {16, 32, 64}. In such embodiments, widths are mapped according to N(l)=max(N_min, G*ceil(N_cont(l)/G)) and optionally post-processed by monotone enforcement N(l+1)=min(N(l), N(l+1)) to prevent rounding artifacts from producing local increases.

In some embodiments, the method 700 includes determining a recognition-derived constant X_opt. In a preferred embodiment, X_opt is computed as X_opt=phi/pi, where phi=(1+sqrt(5))/2 and pi is the circular constant. In other embodiments, X_opt is provided as a stored constant approximating phi/pi to a selected precision, or is computed using an equivalent expression yielding a constant less than 1 and within a neighborhood of the preferred value.

In some embodiments, the method 700 includes generating a continuous layer sizing schedule based on X_opt. For a depth index l, the method computes a continuous width value N_cont(l) according to N_cont(l)=N_base*(X_opt\hat{ }l). In some embodiments, the depth index l begins at 0 for a first layer and increments by 1 for each successive layer. In other embodiments, the depth index corresponds to blocks, stages, or other aggregation units, including in convolutional and attention-based architectures.

In some embodiments, the method 700 includes mapping the continuous schedule to an integer schedule to obtain layer widths N(l). In some embodiments, the integer schedule is generated using a rounding operator, such as N(l)=max(1, ceil(N_cont(l))). In other embodiments, the method uses rounding variants including N(l)=max(1, round(N_cont(l))) or N(l)=max(1, floor(N_cont(l))). In some embodiments, the method applies a minimum width N_min, such that N(l)=max(N_min, rounding(N_cont(l))). In some embodiments, N_min is selected to satisfy deployment constraints, including hardware alignment constraints and minimum representational requirements.

In some embodiments, the method 700 includes applying one or more deployment constraints to the integer schedule. In some embodiments, the method quantizes widths to be divisible by an alignment granularity G, such as 8, 16, or 32, by computing N(l)=max(G, G*ceil(N_cont(l)/G)). In other embodiments, the method applies additional constraints such as an upper bound N_max, stage-based clamping, or other system-or device-specific constraints.

In some embodiments, the method 700 includes enforcing a monotone nonincreasing width schedule across depth to prevent rounding artifacts from producing local increases. In some embodiments, after computing N(l) for each l, the method applies a monotonic enforcement operation such that for each successive layer index l+1, N(l+1) is set to min(N(l), N(l+1)). In other embodiments, monotonic enforcement is applied within stages or within subsets of layers, including within residual block groups.

In some embodiments, after generating the integer width schedule, the method 700 includes instantiating a neural network architecture having layer sizes determined by the schedule. For example, for a multi-layer perceptron, the method creates a sequence of affine layers whose neuron counts are given by N(0), N(1), . . . , N(L-1). For a convolutional neural network, the method configures one or more convolution blocks or stages with channel counts given by a corresponding schedule. For an attention-based network, the method configures one or more architectural sizing parameters such as a hidden dimension, a feed-forward dimension, and/or projection dimensions based on the schedule, optionally subject to integer quantization and divisibility constraints.

In some embodiments, the method 700 includes initializing one or more parameter tensors of the instantiated neural network using a bounded recognition-informed mapping. In some embodiments, raw weight samples W are drawn from a selected initialization distribution, such as a uniform distribution, a normal distribution, a truncated normal distribution, or an orthogonal initialization procedure. The method then computes initialized weights W_init by applying an elementwise transform according to W_init=W/(|W|+X_opt), where |W| denotes an elementwise absolute value. In some embodiments, the transform produces bounded magnitudes such that each element of W_init has magnitude less than 1, and the sign of each nonzero element is preserved.

In some embodiments, the method 700 includes training the neural network using a recognition-informed bounded loss. In some embodiments, during each training iteration, the method performs a forward pass to compute predicted outputs y_hat from input data. The method then computes an error magnitude e based on y and y_hat. In a scalar output embodiment, the method computes e=|y−y_hat|. In a vector output embodiment, the method computes e as a norm or aggregation of elementwise errors, including e=sqrt(sum_j (y_j−y_hat_j)\hat{ }2) or e=sum_j|y_j−y_hat_j|.

In some embodiments, the method computes a recognition coverage value using F_cov(e)=e/(e+X_opt). The method then computes a per-sample loss term L_i based on the recognition coverage value. In a preferred embodiment, the per-sample loss term is computed as L_i=(F_cov(e))\hat{ }2, yielding L_i=(e/(e+X_opt))\hat{ }2. In some embodiments, the method aggregates per-sample loss terms across a batch to produce a batch loss L_batch, including L_batch=sum_i L_i or L_batch=(1/B)*sum_i L_i for a batch size B. In some embodiments, because the per-sample loss term is bounded below 1 for finite error and equals zero at perfect prediction, the resulting training objective reduces the influence of large-error samples relative to unbounded objectives, thereby improving training stability.

In some embodiments, the method 700 includes updating network parameters using backpropagation and an optimizer. In some embodiments, the method computes gradients of the batch loss with respect to model parameters via automatic differentiation or other gradient computation techniques, and applies a parameter update step using a selected optimizer. The selected optimizer may include, by way of example, stochastic gradient descent, momentum-based optimizers, adaptive optimizers including Adam or AdamW, or other gradient-based optimizers. In some embodiments, the method repeats the forward pass, loss computation, gradient computation, and update step for a plurality of iterations until a stopping condition is satisfied, including a convergence criterion, an epoch or step budget, or a performance threshold.

In some embodiments, the stopping condition comprises an acceptance criterion evaluated using one or more validation metrics computed on validation or test data. Non-limiting examples of the validation metrics include validation loss, validation accuracy, area-under-curve, or a task-specific error metric. In one non-limiting example, early stopping is triggered when the validation loss fails to improve by at least a threshold delta (e.g., 0.1% to 1%) over a window of W evaluation events (e.g., 10 to 200), or when the validation metric satisfies a target threshold for at least a selected number of evaluations.

In some embodiments, the method 700 outputs trained model parameters, one or more training metrics, and/or one or more evaluation metrics computed on validation or test data. In some embodiments, the method further outputs a width schedule and/or a record of initialization parameters used, thereby enabling reproducibility and deployment. In some embodiments, the method is executed using mixed-precision arithmetic, distributed training, gradient accumulation, checkpointing, or other training techniques, and the disclosed bounded transforms and bounded loss remain compatible with such training configurations.

In some embodiments, a stability metric comprises at least one of: (i) a rate of NaN/Inf occurrences in activations or gradients, (ii) a running variance of batch loss across mini-batches, (iii) gradient norm statistics including an average or percentile gradient norm, and/or (iv) a frequency of gradient-norm clipping activation. In a non-limiting example, a run is classified as stable if NaN/Inf occurrences are zero and if the running variance of batch loss is below a selected threshold for at least a selected portion of training after an optional warm-up period.

In some embodiments, one or more portions of the method 700 are implemented as library functions or program modules in a training framework. For example, a first module may generate the width schedule, a second module may initialize parameters using the bounded mapping, and a third module may compute the bounded loss. In some embodiments, the modules are provided as reusable components that can be applied to different model classes and training tasks, including regression, classification, forecasting, control, and reinforcement learning.

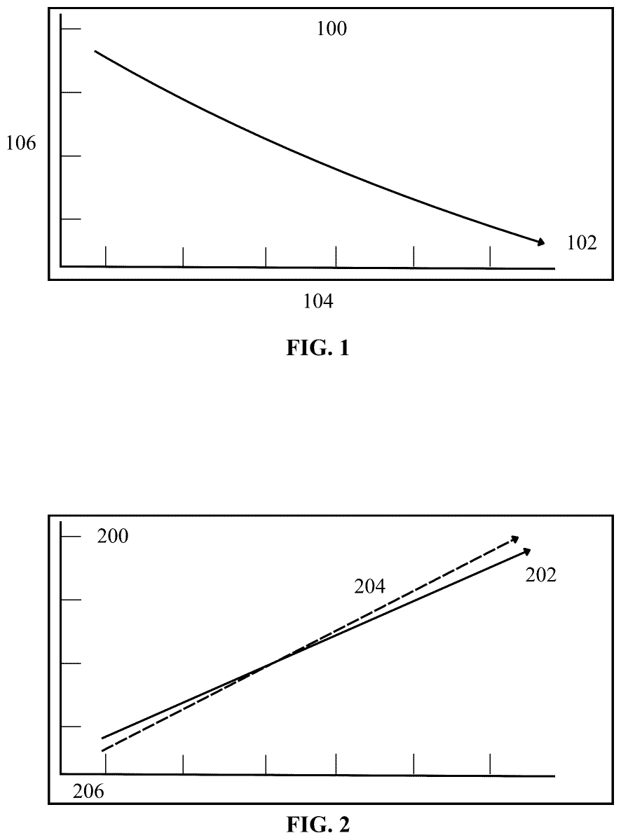

FIG. 1 illustrates an example recognition-informed layer sizing relationship that may be used to configure a neural network architecture. In various embodiments, a base width N_base is selected and successive layer widths are determined as a function of depth using a recognition-derived constant X_opt. In a preferred embodiment, X_opt is defined as X_opt=phi/pi, where phi=(1+sqrt(5))/2 and pi is the circular constant, such that X_opt is less than 1. Because X_opt is less than 1, the resulting continuous width schedule decreases with depth for positive N_base.

In the illustrated embodiment of FIG. 1, a plot region 100 schematically depicts an example tapering schedule curve 102. Representative tick marks 104 and 106 are shown to illustrate axes graduations, without limiting any particular scale or unit.

In various embodiments, for a layer index l, a continuous width value N_cont(l) is computed according to N_cont(l)=N_base*(X_opt\hat{ }l). In some embodiments, l=0 corresponds to a first layer to which the width schedule is applied, and l increments by 1 for each successive layer. In other embodiments, the depth index corresponds to blocks, stages, attention layers, or other layer groupings. In some embodiments, the schedule may be applied across all layers. In other embodiments, the schedule may be applied across a subset of layers, such as across hidden layers while leaving an input embedding size and/or output layer size fixed.

In various embodiments, the continuous width schedule N_cont(l) is mapped to an integer schedule N(l) for use in defining an implementable architecture. In some embodiments, the integer mapping uses a ceiling operation, such that N(l)=max(1, ceil(N_cont(l))). In other embodiments, the integer mapping uses rounding to nearest integer, such that N(l)=max(1, round(N_cont(l))). In other embodiments, the integer mapping uses a floor operation, such that N(l)=max(1, floor(N_cont(l))). In still other embodiments, the integer mapping uses stochastic rounding. Any of the foregoing integer mappings may be selected based on implementation preference and deployment constraints. In some embodiments, a minimum width constraint is applied such that each width is at least a selected minimum N_min. In such embodiments, the integer mapping may be written as N(l)=max(N_min, rounding(N_cont(l))). In some embodiments, N_min is selected based on model type, deployment hardware constraints, or application requirements. For example, in some embodiments N_min is selected to be a multiple of a hardware vector width or accelerator tile size. In some embodiments, an upper bound N_max is also applied such that N(l)=min(N_max, N(l)).

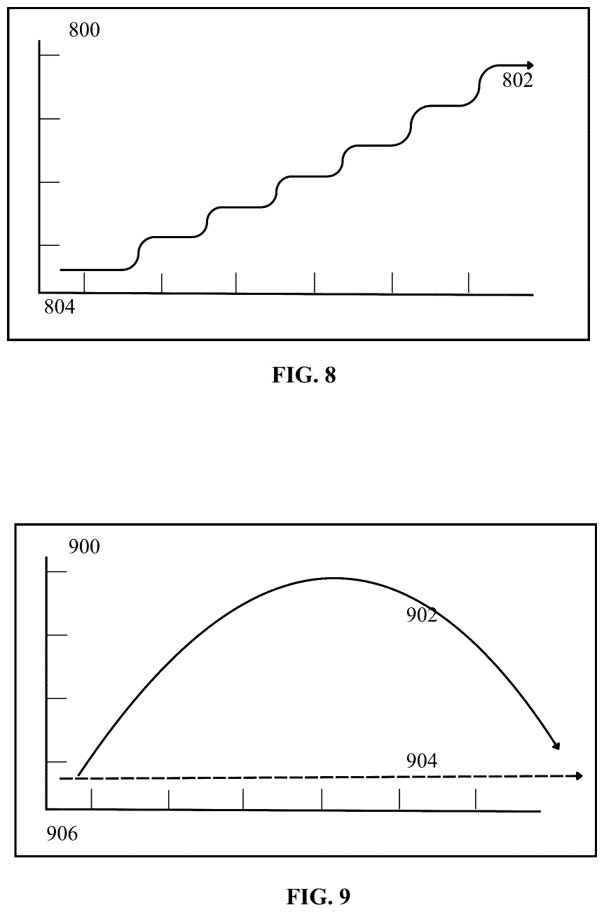

FIG. 8 illustrates example integer mapping and deployment constraints that may be applied to the recognition-informed width schedule. In some embodiments, the method enforces divisibility by a hardware alignment granularity G, such as 8, 16, or 32, to improve computational efficiency and to satisfy accelerator constraints. In such embodiments, a hardware-aligned width may be computed as N(l)=max(G, G*ceil(N_cont(l)/G)). In other embodiments, hardware alignment is enforced by rounding to nearest multiple of G. In still other embodiments, the mapping includes both a minimum width constraint and a granularity constraint. In some embodiments, enforcing such alignment reduces padding overhead and improves accelerator kernel utilization.

In the illustrated embodiment of FIG. 8, a plot region 800 schematically depicts a staircase mapping 802 corresponding to an integer mapping and/or quantization of a continuous schedule. Representative tick marks 804 are shown to illustrate axes graduations, without limiting any particular scale or unit.

In some embodiments, the integer mapping includes an enforcement operation that maintains a monotone nonincreasing width schedule across depth. This can be beneficial because integer rounding may cause local increases even when the continuous schedule is decreasing. In some embodiments, after computing an initial integer schedule N(l), a monotonic enforcement operation is applied such that for each successive layer index l+1, N(l+1) is set to min(N(l), N(l+1)). In other embodiments, monotonic enforcement is applied within groups such as within stages, within residual blocks, or within attention blocks, while permitting selected transitions between groups.

In some embodiments, the recognition-informed width schedule is applied to different architectural sizing parameters depending on the model type. For an MLP, N(l) may define a number of neurons for each affine layer. For a convolutional neural network, N(l) may define a channel count for a convolution block or stage. For an attention-based network, N(l) may define a hidden dimension, a feed-forward dimension, and/or projection dimensions, optionally with constraints such as divisibility by a number of attention heads. For a graph neural network, N(l) may define a message-passing hidden dimension. For an encoder-decoder model, the schedule may be applied to an encoder path, a decoder path, or both.

In some embodiments, the schedule is applied in a stage-based manner rather than uniformly per layer. For example, in some embodiments a stage index s is used to define stage widths N_stage(s)=N_base*(X_opt\hat{ }s), and each stage width is repeated across a plurality of layers within the corresponding stage. This can be beneficial for architectures that are naturally organized into stages, including convolutional networks with repeated blocks per stage and transformer models with repeated layers. In some embodiments, stage boundaries may correspond to changes in spatial resolution, receptive field, or attention context length.

In some embodiments, the schedule is applied to only a portion of a network while leaving other portions fixed or independently determined. For example, in some embodiments an input embedding dimension is fixed while intermediate layers follow the recognition-informed schedule. In some embodiments, an output layer dimension is fixed to match a number of classes or regression targets. In some embodiments, the recognition-informed schedule is applied to a subset of layers selected based on sensitivity to overparameterization or computational budget.

In some embodiments, the base width N_base is selected based on a parameter budget, a compute budget, or a memory budget. In some embodiments, the base width is selected to satisfy a target parameter count by estimating a parameter count as a function of N_base, X_opt, and depth. In some embodiments, the base width is selected to satisfy a target inference latency or throughput constraint by estimating compute cost as a function of layer widths and operator types. In some embodiments, the base width is selected based on a deployment device class, including edge devices having limited memory and compute.

In various embodiments, the recognition-informed width schedule provides a systematic approach to configuring architectures in which width decreases with depth in a controlled manner while remaining compatible with standard neural network building blocks. In practice, the resulting architectures may reduce parameter count and computational cost relative to uniform-width architectures while maintaining performance, and may reduce manual architecture tuning by providing a deterministic and reproducible schedule derived from a constant X_opt.

FIG. 2 illustrates an example recognition-informed weight initialization mapping that may be used to initialize parameters of a neural network. In various embodiments, one or more parameter tensors are initialized by first generating raw weight samples W according to a selected initialization procedure and then applying a bounded mapping to produce initialized weights W_init. The bounded mapping may be applied elementwise to scalars, vectors, matrices, or higher-dimensional tensors.

In some embodiments, raw weight samples W are generated using any suitable initialization distribution or procedure, including a uniform distribution, a normal distribution, a truncated normal distribution, a variance-preserving initialization, an orthogonal initialization, or any other initialization method. In some embodiments, W is generated with a mean of approximately zero. In other embodiments, W may be generated with a nonzero mean. In still other embodiments, the initialization may be conditioned on fan-in, fan-out, activation type, or layer type. Regardless of the raw initialization procedure, in various embodiments the bounded mapping described herein is applied as a post-processing transform.

In a preferred embodiment, initialized weights W_init are computed according to W_init=W/(|W|+X_opt), where |W| denotes the elementwise absolute value and X_opt is a recognition-derived constant. In a preferred embodiment, X_opt is defined as X_opt=phi/pi, where phi=(1+sqrt(5))/2 and pi is the circular constant. In other embodiments, X_opt is provided as a stored constant approximating phi/pi to a selected precision or computed using an equivalent expression yielding a constant less than 1 within a neighborhood of the preferred value.

In various embodiments, the mapping W_init=W/(|W|+X_opt) yields bounded initialized weights. For each nonzero element W_k of W, the corresponding element W_init, k has magnitude |W_init, k|=|W_k|/(|W_k|+X_opt), which is strictly less than 1 for finite W_k and positive X_opt. In some embodiments, this bound reduces a likelihood of unstable early training dynamics associated with large-magnitude parameters, including large activations and large gradients in early optimization steps.

In various embodiments, the mapping W_init=W/(|W|+X_opt) preserves sign for nonzero raw weights. Specifically, for an element W_k>0, the corresponding element W_init, k is positive, and for an element W_k<0, the corresponding element W_init, k is negative. For an element W_k=0, the corresponding element W_init, k is 0. In some embodiments, sign preservation can be desirable to preserve relative directional structure of a selected raw initialization procedure while bounding magnitude.

In some embodiments, the bounded mapping is applied to all trainable weight tensors of a model. In other embodiments, the bounded mapping is applied to a selected subset of tensors, including, by way of example, affine weight matrices, convolution kernels, attention projection matrices, embedding tables, or output heads. In some embodiments, the bounded mapping is also applied to bias parameters. In other embodiments, biases are initialized using a separate procedure, including zero initialization, while weights are initialized using the bounded mapping.

In some embodiments, the bounded mapping includes a stabilization term epsilon to avoid numerical issues in the presence of very small denominators or to ensure stable computation in limited precision arithmetic. For example, in some embodiments, W_init is computed as W_init=W/(|W|+X_opt+epsilon), where epsilon is a small nonnegative value. In some embodiments, epsilon is selected as a machine-epsilon-scaled value suitable for float16, bfloat16, float32, or float64 computation.

In some embodiments, the bounded mapping is applied elementwise as described above. In other embodiments, the bounded mapping is applied using a tensor-level or channel-level magnitude measure. For example, in some embodiments a tensor norm s is computed, such as an L2 norm or Frobenius norm of a tensor W, and a bounded initialization is computed as W_init=W/(s+X_opt). In other embodiments, a per-channel norm is computed for convolution kernels or grouped weights, and each channel group is scaled according to W_init[c]=W[c]/(s_c+X_opt), where s_c is a norm for channel group c. In some embodiments, elementwise mapping and norm-based mapping are combined, including by applying the elementwise mapping followed by an additional scaling step.

In some embodiments, the bounded mapping is used in combination with the recognition-informed width schedule described herein. For example, in some embodiments a model is constructed using widths determined according to N_cont(l)=N_base*(X_opt\hat{ }l) and mapped to integers, and the resulting model is then initialized using W_init=W/(|W|+X_opt). In other embodiments, the bounded mapping is used independently of layer sizing, including in a fixed-width model selected by a user or by another automated procedure.

In various embodiments, the bounded initialization is compatible with standard training frameworks and hardware accelerators. In some embodiments, the bounded mapping is implemented as an elementwise tensor operation supported by common tensor libraries and can be executed efficiently on GPUs and other accelerators. In some embodiments, the bounded initialization may be applied deterministically given a random seed and a defined raw initialization procedure, thereby supporting reproducibility across training runs.

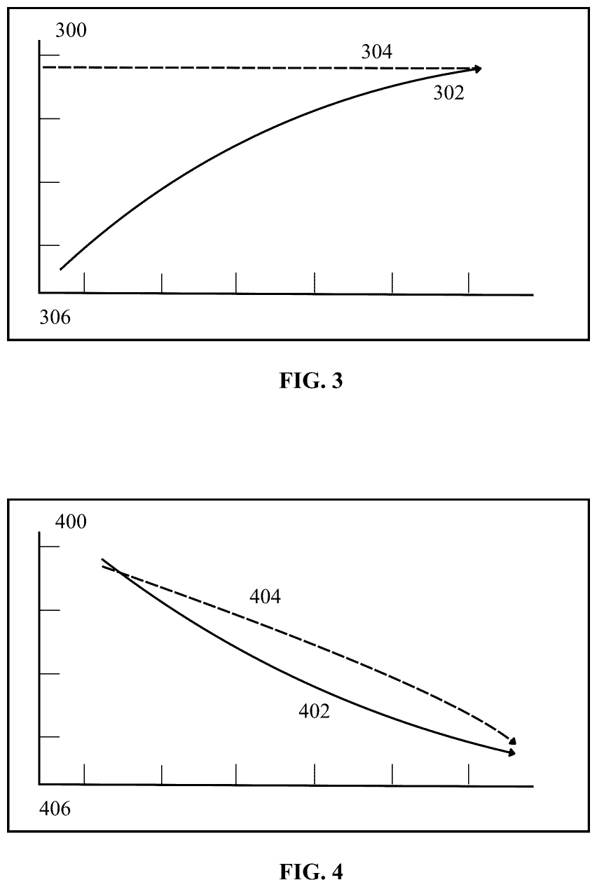

FIG. 3 illustrates an example recognition-informed bounded loss function that may be used to train a neural network. In various embodiments, the bounded loss is computed from a nonnegative error magnitude and a recognition-derived constant X_opt. In a preferred embodiment, X_opt is defined as X_opt=phi/pi, where phi=(1+sqrt(5))/2 and pi is the circular constant. In other embodiments, X_opt is provided as a stored constant approximating phi/pi to a selected precision, or computed using an equivalent expression yielding a constant less than 1 within a neighborhood of the preferred value.

In the illustrated embodiment of FIG. 3, a plot region 300 schematically depicts a bounded loss curve 302. An upper bound reference line 304 is shown to illustrate bounded behavior, and representative tick marks 306 are shown to illustrate axes graduations, without limiting any particular scale or unit.

In some embodiments, a recognition coverage function is defined as F_cov(r)=r/(r+X_opt) for r greater than or equal to zero. In various embodiments, F_cov(r) is monotone increasing in r and yields a bounded value in the interval [0, 1) for finite r. In some embodiments, the recognition coverage function is used to define a per-sample loss term, which is then aggregated across samples in a batch to obtain a batch loss used for parameter updates.

In a preferred scalar-output embodiment, the method computes an absolute error magnitude e=|y−y_hat|, where y is a target output and y_hat is a predicted output. The method then computes a per-sample loss term as L_i=(F_cov(e))\hat{ }2, yielding L_i=(e/(e+X_opt))\hat{ }2. In some embodiments, a batch loss is computed as L_batch=sum_i L_i across samples i of a batch. In other embodiments, a mean reduction is used, such that L_batch=(1/B)*sum_i L_i for a batch size B.

In various embodiments, the per-sample loss term L_i is bounded and well-behaved. For finite error magnitude e and positive X_opt, the quantity e/(e+X_opt) is strictly less than 1, and thus the squared loss term satisfies 0<=L_i<1. In some embodiments, this boundedness reduces the ability of any single sample to dominate the batch loss magnitude. In addition, for perfect prediction where e=0, the loss term is L_i=0, thereby yielding zero loss at perfect prediction.

In some embodiments, the bounded loss is used for vector outputs or structured outputs by defining an aggregated error magnitude e from elementwise errors. In some embodiments, the method computes e using an L1 aggregation e=sum_j |y_j−y_hat_j| over output indices j. In other embodiments, the method computes e using an L2 norm e=sqrt(sum_j (y_j−y_hat_j)\hat{ }2). In still other embodiments, the method computes a per-dimension bounded loss and aggregates per-dimension losses, such as L_i=sum_j (|y_j−y_hat_j|/(|y_j−y_hat_j|+X_opt))\hat{ }2. In each such embodiment, the resulting loss remains bounded as a function of the selected aggregation.

In some embodiments, the bounded loss is adapted for classification tasks. In some embodiments, for a model that outputs logits, the logits are transformed to probabilities using a softmax function to obtain a probability vector p. For a one-hot target vector y, the method computes an error magnitude e=sum_k |y_k−p_k| and computes a bounded per-sample loss L_i=(e/(e+X_opt))\hat{ }2. In other embodiments, the method computes a cross-entropy value CE and applies the recognition coverage function to CE, including L_i=(CE/(CE+X_opt))\hat{ }2, thereby yielding a bounded surrogate objective derived from cross-entropy. In still other embodiments, the bounded loss is applied to a margin-based error quantity for binary classification.

FIG. 9 illustrates example bounded-gradient behavior associated with the recognition-informed bounded loss. In various embodiments, the bounded loss yields gradients that are bounded in magnitude as a function of the error, thereby reducing sensitivity to large-error samples. In a scalar-output embodiment with e=|y−y_hat|and L=(e/(e+X_opt))\hat{ }2, a derivative with respect to y_hat exists for y_hat not equal to y and may be expressed using a signed error term d=y−y_hat. In such embodiments, for d not equal to zero, a derivative may be written as dL/d(y_hat)=−2*X_opt*d/(|d|+X_opt)\hat{ }3. In some embodiments, the derivative at d=0 is treated using a subgradient consistent with the absolute value operation, or the absolute value is smoothed as described herein.

In the illustrated embodiment of FIG. 9, a plot region 900 schematically depicts a gradient behavior curve 902 associated with bounded loss behavior. A baseline reference line 904 is shown for comparison, and representative tick marks 906 are shown to illustrate axes graduations, without limiting any particular scale or unit.

In various embodiments, the magnitude of the gradient associated with the bounded loss is bounded for finite error magnitudes. For the scalar-output embodiment described above, the gradient magnitude |dL/d(y_hat)| decreases for sufficiently large |d| because the denominator (|d|+X_opt)\hat{ }3 grows faster than the numerator. In some embodiments, this behavior reduces instability associated with large-error samples and reduces outlier dominance relative to unbounded losses whose gradient magnitudes can grow without bound.

In some embodiments, a smooth approximation is used for the absolute value to obtain a differentiable loss at all error values. In such embodiments, the method computes a smoothed error magnitude e=sqrt((y−y_hat)\hat{ }2+epsilon\hat{ }2), where epsilon is a small positive value, and computes the bounded loss using L_i=(e/(e+X_opt))\hat{ }2. In some embodiments, epsilon is selected based on numeric precision and stability considerations.

In some embodiments, the bounded loss uses a power other than 2. For example, in some embodiments, the per-sample loss is computed as L_i=(e/(e+X_opt))\hat{ }p for a selected exponent p greater than 0. In some embodiments, p is selected to balance robustness and sensitivity for a particular task. In other embodiments, the error magnitude is transformed using a power q prior to applying the recognition coverage function, such that L_i=(e\hat{ }q/(e\hat{ }q+X_opt\hat{ }q))\hat{ }2 for q greater than 0. In each such embodiment, the loss remains bounded for finite error magnitude.

In various embodiments, the bounded loss is compatible with standard backpropagation and gradient-based optimization. In some embodiments, the bounded loss is computed as an elementwise tensor operation and is differentiable or subdifferentiable, enabling use with automatic differentiation libraries. In some embodiments, the bounded loss is used with optimizers including stochastic gradient descent, Adam, AdamW, and other optimizers, and can be combined with standard training techniques including learning rate schedules, gradient clipping, weight decay, normalization layers, dropout, and mixed-precision training.

In various embodiments, the bounded loss provides a predictable per-sample contribution and bounded gradient behavior that may improve training stability, particularly in the presence of outliers, label noise, or distribution shift. In some embodiments, the bounded loss is used alone. In other embodiments, the bounded loss is used in combination with recognition-informed layer sizing and/or recognition-informed weight initialization, thereby providing a coordinated set of training improvements based on the recognition-derived constant X_opt.

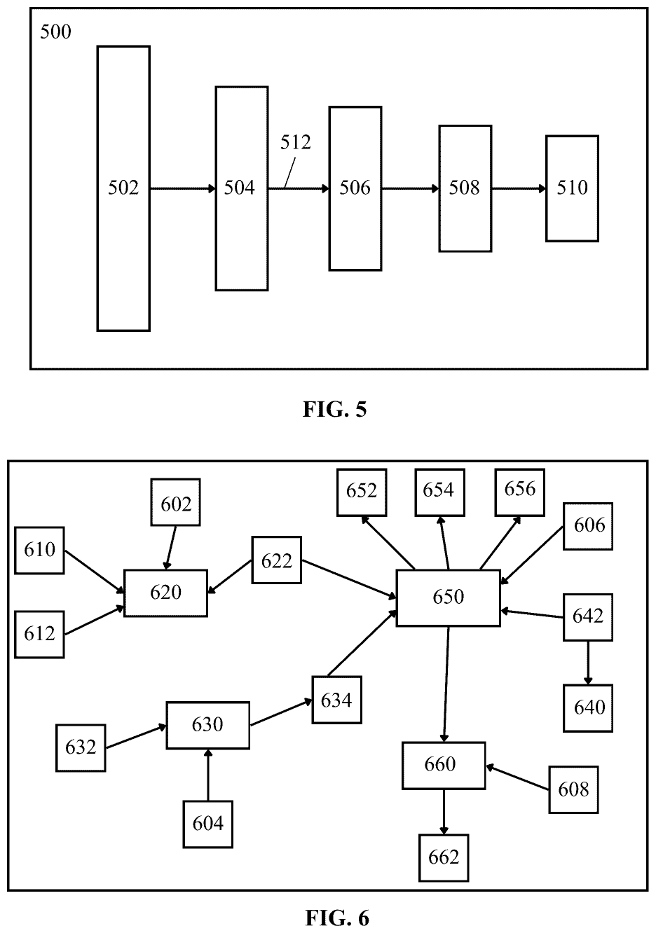

FIG. 5 illustrates an example neural network architecture consistent with a recognition-informed width schedule. In some embodiments, a base width N_base is selected and successive layer widths are determined using N_cont(l)=N_base*(X_opt\hat{ }l) mapped to integers as described herein. The resulting architecture may include a first layer having approximately N_base units, followed by successive layers having widths that decrease with depth according to the constant X_opt. In some embodiments, the architecture is implemented as a multi-layer perceptron for regression or classification tasks. In other embodiments, the architecture corresponds to channel schedules for convolutional blocks, hidden dimensions for attention-based blocks, or message-passing dimensions for graph neural networks.

In the illustrated embodiment of FIG. 5, an example neural network architecture 500 includes successive layers 502, 504, 506, 508, and 510 coupled by interconnects 512. The illustrated layers are schematic and may correspond to affine layers, convolution blocks, attention blocks, or other compositional units depending on model type.

FIG. 4 illustrates example training behavior in which training using one or more RINNO components exhibits improved convergence characteristics relative to one or more baseline techniques. In some embodiments, the illustrated behavior includes improved convergence speed, reduced oscillation, reduced sensitivity to random seeds, and/or improved final performance metrics. In various embodiments, FIG. 4 is illustrative and non-limiting, and the disclosed techniques may be used with a variety of model types, datasets, and training configurations.

In the illustrated embodiment of FIG. 4, a plot region 400 schematically depicts a first training trajectory 402 and a second training trajectory 404. Representative tick marks 406 are shown to illustrate axes graduations, without limiting any particular scale or unit.

In some embodiments, a training pipeline applies recognition-informed layer sizing, recognition-informed weight initialization, and the recognition-informed bounded loss together in a single training run. For example, in some embodiments, the pipeline selects N_base and depth L, computes a width schedule using N_cont(l)=N_base*(X_opt\hat{ }l) with rounding and constraints, constructs a model using the resulting integer widths, initializes parameters using W_init=W/(|W|+X_opt), and trains the model using a loss computed as L_i=(e/(e+X_opt))\hat{ }2 aggregated across samples. In some embodiments, the pipeline performs parameter updates using AdamW. In other embodiments, stochastic gradient descent or another optimizer is used.

In some embodiments, recognition-informed layer sizing is used independently of the bounded initialization and bounded loss. For example, in some embodiments, a user may wish to obtain a deterministic tapering architecture while retaining a baseline initialization procedure and a baseline loss such as mean squared error or cross-entropy. In such embodiments, the system constructs the model using the recognition-informed width schedule and trains using the selected baseline components.

In some embodiments, recognition-informed weight initialization is used independently of recognition-informed layer sizing and the bounded loss. For example, in some embodiments, a fixed architecture is selected by a user or determined by an external architecture search process, and the system initializes weights using the bounded mapping W_init=W/(|W|+X_opt). In some embodiments, the bounded initialization is applied to selected subsets of parameters such as attention projections or convolution kernels, while other parameters are initialized using baseline techniques.

In some embodiments, the recognition-informed bounded loss is used independently of recognition-informed layer sizing and bounded initialization. For example, in some embodiments, a baseline model architecture and baseline initialization are used, and the system trains using the bounded loss L_i=(e/(e+X_opt))\hat{ }2. In such embodiments, the bounded loss provides bounded per-sample contributions and bounded gradient behavior while maintaining compatibility with standard training loops and optimizers.

In some embodiments, the disclosed techniques are implemented within a training framework as one or more software components. In some embodiments, the layer sizing procedure is implemented as a function that generates integer widths given inputs N_base, L, and one or more constraints. In some embodiments, the bounded initialization is implemented as a tensor transformation that is applied to parameter tensors at initialization time. In some embodiments, the bounded loss is implemented as a callable function or class that receives y and y_hat (or logits and targets) and returns a scalar loss value. In various embodiments, the software components may be implemented in a framework including PyTorch, TensorFlow, Keras, JAX, or other frameworks, and may be implemented in a manner compatible with automatic differentiation.

In some embodiments, the disclosed techniques are applied to regression tasks including time series forecasting, function approximation, and control. In such embodiments, y and y_hat may be scalar values or vectors, and an error magnitude e may be computed using an absolute error, an L1 aggregation, or an L2 norm. In some embodiments, the bounded loss reduces sensitivity to outliers in regression datasets, including datasets having heavy-tailed error distributions.

In some embodiments, the disclosed techniques are applied to classification tasks. In such embodiments, a model may output logits that are transformed to probabilities and compared to a target label distribution. In some embodiments, an error magnitude is computed in probability space and mapped through the bounded loss. In other embodiments, a baseline classification objective such as cross-entropy is computed and then transformed to a bounded surrogate using the recognition coverage function, including L_i=(CE/(CE+X_opt))\hat{ }2. In some embodiments, the bounded classification objective yields improved stability when the model is initially far from the target distribution.

In some embodiments, the disclosed techniques are applied to neural networks deployed under resource constraints, including edge devices having limited memory and compute. In such embodiments, recognition-informed layer sizing may reduce model parameter count and compute cost while maintaining performance. In some embodiments, hardware alignment constraints are applied to the width schedule as described herein to improve accelerator utilization. In some embodiments, the resulting trained model is deployed to a device, and inference is performed using trained parameters produced by the disclosed training procedure.

In some embodiments, the disclosed techniques are applied in distributed training environments. In such embodiments, training data may be distributed across devices and parameter updates may be synchronized using data-parallel or model-parallel techniques. In some embodiments, the bounded initialization and bounded loss remain compatible with mixed-precision arithmetic and distributed gradient aggregation. In some embodiments, the disclosed bounded loss reduces training instability that can be exacerbated by large batch sizes or distributed gradient variance.

In some embodiments, one or more mathematical properties of the disclosed functions are verified. In some embodiments, the system verifies that X_opt is less than 1, that the width schedule decreases with depth under a continuous formulation, that the bounded initialization yields |W_init|<1, and that the bounded loss yields per-sample loss terms in [0, 1) with zero at perfect prediction. In some embodiments, the system additionally verifies monotonicity properties of the recognition coverage function and the bounded loss with respect to error magnitude. In some embodiments, such verification provides additional assurance that the disclosed bounds and behaviors hold as implemented.

The disclosed embodiments are illustrative and non-limiting. In various embodiments, any of the disclosed features may be combined, omitted, substituted, or modified. For example, rounding and quantization choices may vary, the bounded loss may be applied to different error definitions, and the bounded initialization may be applied elementwise or using tensor-level norms. In each case, the disclosed recognition-informed constant and bounded functional forms may be used to improve training stability and efficiency while maintaining compatibility with standard training infrastructure.

In various embodiments, the methods described herein are performed by one or more computing devices comprising one or more processors and one or more memories storing instructions that, when executed by the one or more processors, cause the one or more computing devices to perform the disclosed operations. In some embodiments, the one or more processors include a central processing unit, a graphics processing unit, a tensor processing unit, a neural processing unit, a field-programmable gate array, an application-specific integrated circuit, or any combination thereof. In some embodiments, the one or more memories include volatile memory, non-volatile memory, or any combination thereof, and may include one or more storage devices.

In some embodiments, the disclosed techniques are implemented using a non-transitory computer-readable medium storing instructions that, when executed by one or more processors, cause performance of operations comprising determining a recognition-derived constant X_opt, generating a layer sizing schedule using X_opt, initializing one or more parameter tensors using a bounded mapping based on X_opt, computing a bounded loss based on prediction error and X_opt, and iteratively updating model parameters using a gradient-based optimizer. In some embodiments, the computer-readable medium comprises one or more of a hard disk, solid state storage, flash memory, optical storage, or other non-transitory storage media.

In some embodiments, the disclosed techniques are implemented as one or more software components executed in a training framework, including as a library, package, module, class, set of functions, microservice, or other programmatic interface. In some embodiments, the disclosed techniques are exposed as application programming interfaces that accept training data and model configuration parameters and output trained model parameters, a width schedule, and one or more training metrics. In some embodiments, the disclosed techniques are integrated into an automated model construction pipeline that generates architectures under parameter budgets or compute budgets and trains the generated architectures using bounded initialization and bounded loss.

In some embodiments, the disclosed techniques are implemented in environments that include distributed training across multiple devices, including data-parallel training and model-parallel training. In such embodiments, parameter updates may be synchronized using gradient aggregation, parameter server architectures, ring all-reduce operations, or other distributed training mechanisms. In some embodiments, the bounded loss and bounded initialization remain compatible with distributed training and help reduce training instability in the presence of large batch sizes or heterogeneous data partitions.

In some embodiments, the disclosed techniques are implemented using mixed-precision arithmetic. In such embodiments, computations may be performed using float16, bfloat16, float32, float64, or combinations thereof. In some embodiments, loss scaling, gradient scaling, and other numeric-stability techniques are used, and the disclosed bounded transforms reduce the magnitude of intermediate values, thereby improving numeric stability and reducing overflow risk in limited-precision regimes.

In some embodiments, the disclosed techniques are implemented with additional training controls, including gradient clipping, learning rate schedules, warm-up schedules, weight decay, dropout, normalization layers, residual connections, and other training and architecture features. In some embodiments, such controls are used in combination with the disclosed recognition-informed layer sizing, bounded initialization, and bounded loss. In some embodiments, the disclosed techniques operate as drop-in components, enabling adoption without replacing existing optimizers or training infrastructure.

In some embodiments, the disclosed recognition-informed functional forms are modified while retaining boundedness and monotonicity properties. For example, in some embodiments, the per-sample loss term is computed as L_i=(e/(e+X_opt))\hat{ }p for an exponent p greater than 0, including p=1, p=2, or another value. In some embodiments, the error magnitude is transformed prior to applying the recognition coverage function, including by computing e\hat{ }q for q greater than 0. In some embodiments, the bounded weight mapping includes a small stabilization term epsilon, such that W_init=W/(|W|+X_opt+epsilon). In some embodiments, the layer sizing schedule is applied on a per-layer basis, on a per-stage basis, or to selected architectural sizing parameters while leaving other parameters fixed.

In some embodiments, the disclosed recognition-derived constant X_opt is computed as phi/pi. In other embodiments, X_opt is stored as a numerical constant approximating phi/pi to a selected precision. In still other embodiments, X_opt is computed using an equivalent expression that yields a constant less than 1 and within a neighborhood of the preferred value. In some embodiments, X_opt is used in one component of RINNO but not another, including embodiments in which the width schedule uses X_opt while the bounded loss uses a different bounded mapping constant, or vice versa.

It will be understood that the disclosed embodiments are exemplary and non-limiting, and that features described with respect to one embodiment may be combined with features described with respect to other embodiments. The scope of the disclosure is defined by the claims and their equivalents, and not by the foregoing description.

What is claimed is:

1. A method for training a neural network, comprising: determining a recognition-derived constant X_opt that is less than 1; generating a layer width schedule for a plurality of layers as a function of depth using the constant X_opt; instantiating the neural network in accordance with the layer width schedule; initializing one or more parameter tensors of the neural network by applying a bounded mapping based on X_opt to raw parameter values to produce initialized parameter values having magnitudes less than 1; training the neural network on training data by computing, for each training iteration, a bounded loss based on a prediction error and the constant X_opt; and updating the initialized parameter values using backpropagation and a gradient-based optimizer.

2. The method of claim 1, wherein the constant X_opt is defined as X_opt=phi/pi, where phi=(1+sqrt(5))/2 and pi is the circular constant.

3. The method of claim 1, wherein generating the layer width schedule comprises computing a continuous width value for a layer index l as N_cont(l)=N_base*(X_opt\hat{ }l), where N_base is a base width.

4. The method of claim 3, further comprising mapping the continuous width value N_cont(l) to an integer width N(l) using a rounding operator.

5. The method of claim 4, wherein the rounding operator comprises a ceiling operation such that N(l)=max(1, ceil(N_cont(l))).

6. The method of claim 4, wherein mapping to the integer width comprises quantizing the integer width to be divisible by an alignment granularity G by computing N(l)=max(G, G*ceil(N_cont(l)/G)).

7. The method of claim 4, further comprising enforcing a monotone nonincreasing width schedule across depth by setting, for each successive layer index l+1, N(l+1)=min(N(l), N(l+1)).

8. The method of claim 1, wherein applying the bounded mapping comprises computing initialized weights W_init from raw weights W according to W_init=W/(abs(W)+X_opt), where abs(W) denotes an elementwise absolute value.

9. The method of claim 8, wherein computing W_init comprises computing W_init=W/(abs(W)+X_opt+eps), where eps is a nonnegative stabilization term selected in a range from 10\hat{ }l -8 to 10\hat{ }-3.

10. The method of claim 8, wherein the bounded mapping is sign-preserving for nonzero raw weights such that a sign of each nonzero element of W_init matches a sign of a corresponding element of W.

11. The method of claim 1, wherein a training run selects a base width N_base in a range of 64 to 4096, a depth L in a range of 4 to 200 layers or blocks, an alignment granularity G selected from {8, 16, 32, 64}, and a minimum width N_min selected from {16, 32, 64}, and wherein generating the layer width schedule comprises mapping a continuous width schedule to integer widths according to N(l)=max(N_min, G*ceil(N_cont(l)/G)).

12. The method of claim 1, wherein computing the bounded loss comprises computing an error magnitude e based on a target output y and a predicted output y_hat as e=|y−y_hat|.

13. The method of claim 12, wherein computing the bounded loss comprises computing a per-sample loss term L_i=(e/(e+X_opt))\hat{ }2.

14. The method of claim 1, wherein computing the bounded loss comprises computing an error magnitude e for vector outputs using an aggregation selected from: e=sum_j|y_j−y_hat_j|, and e=sqrt(sum_j (y_j−y_hat_j)\hat{ }2).

15. The method of claim 1, wherein computing the bounded loss for a classification task comprises transforming logits to probabilities p, computing an error magnitude e=sum_k|y_k−p_k| for a target label distribution y, and computing a per-sample loss term L_i=(e/(e+X_opt))\hat{ }2.

16. The method of claim 1, wherein computing the bounded loss comprises computing a baseline loss value CE and computing a bounded surrogate loss term L_i=(CE/(CE+X_opt))\hat{ }2.

17. The method of claim 1, further comprising computing a stability metric during training, wherein the stability metric comprises at least one of: (i) a rate of NaN/Inf occurrences in activations or gradients, (ii) a running variance of batch loss across mini-batches, (iii) gradient norm statistics, or (iv) a frequency of gradient-norm clipping activation.

18. The method of claim 1, wherein training is terminated based on an acceptance criterion evaluated using a validation metric, and wherein early stopping is triggered when the validation metric fails to improve by at least a threshold delta over a window of W evaluation events.

19. A system for training a neural network, comprising: one or more processors; and one or more non-transitory memories storing instructions that, when executed by the one or more processors, cause the system to: determine a recognition-derived constant X_opt that is less than 1; generate a layer width schedule for a plurality of layers using X_opt; instantiate the neural network in accordance with the layer width schedule; initialize one or more parameter tensors of the neural network by applying a bounded mapping based on X_opt to raw parameter values to produce initialized parameter values having magnitudes less than 1; compute, during training, a bounded loss based on a prediction error and X_opt; and update parameters of the neural network using backpropagation and a gradient-based optimizer.

20. A non-transitory computer-readable medium storing instructions that, when executed by one or more processors, cause the one or more processors to perform operations comprising: determining a recognition-derived constant X_opt that is less than 1; generating a layer width schedule using X_opt; instantiating a neural network in accordance with the layer width schedule; initializing one or more parameter tensors by applying a bounded mapping based on X_opt to raw parameter values; training the neural network by computing a bounded loss based on a prediction error and X_opt; and updating parameters using backpropagation and a gradient-based optimizer.
